(19) United States
(12) Patent Application Publication
(10) Pub. No.: US 2010/0106704 A1
(43) Pub. Date: Apr. 29, 2010

(54) CROSS-LINGUAL QUERY CLASSIFICATION

(75) Inventors: Vanja Josifovski, Los Gatos, CA (US); Evgeniy Gabrilovich, Sunnyvale, CA (US); Andrei Broder, Menlo Park, CA (US); Bo Pang, Sunnyvale, CA (US); Xuerui Wang, Santa Clara, CA (US)

Correspondence Address: BERKELEY LAW & TECHNOLOGY GROUP LLP, 17933 NW EVERGREEN PARKWAY, SUITE 250, BEAVERTON, OR, 97006, US

(73) Assignee: Yahoo! Inc., Sunnyvale, CA (US)

(21) Appl. No.: 12/260,812

(22) Filed: Oct. 29, 2008

(51) Int. Cl. G06F 17/30; G06F 17/28; G06F 7/00

(52) U.S. Cl. 707/708; 704/7; 707/E17.014; 707/E17.136

(57) ABSTRACT

The subject matter disclosed herein relates to cross-lingual query classification.

### BACKGROUND

1. Field

The subject matter disclosed herein relates to data processing, and more particularly to methods and apparatuses that may be implemented to develop a hierarchical taxonomy based at least in part on a cross-lingual query classification through one or more computing platforms and/or other like devices.

2. Information

Data processing tools and techniques continue to improve. Information in the form of data is continually being generated or otherwise identified, collected, stored, shared, and analyzed. Databases and other like data repositories are common place, as are related communication networks and computing resources that provide access to such information.

The Internet is ubiquitous; the World Wide Web provided by the Internet continues to grow with new information seemingly being added every second. To provide access to such information, tools and services are often provided, which allow for the copious amounts of information to be searched through in an efficient manner. For example, service providers may allow for users to search the World Wide Web or other like networks using search engines. Similar tools or services may allow for one or more databases or other like data repositories to be searched. With so much information being available, there is a continuing need for methods and systems that allow for pertinent information to be analyzed in an efficient manner.

### BRIEF DESCRIPTION OF DRAWINGS

Claimed subject matter is particularly pointed out and distinctly claimed in the concluding portion of the specification. However, both as to organization and/or method of operation, together with objects, features, and/or advantages thereof, it may best be understood by reference to the following detailed description when read with the accompanying drawings in which:

FIG. 1 is a procedure for developing a hierarchical taxonomy based at least in part on a cross-lingual query classification in accordance with one or more exemplary embodiments.

FIG. 2 is a table illustrating simulated results in accordance with one or more exemplary embodiments.

FIG. 3 is a procedure for developing a hierarchical taxonomy based at least in part on a cross-lingual query classification in accordance with one or more exemplary embodiments.

FIG. 4 is a procedure for determining if a lingual translation of a query is accurate in accordance with one or more exemplary embodiments.

FIG. 4 is a procedure for determining if a lingual translation of a query is accurate in accordance with one or more exemplary embodiments.

FIG. 6 is a block diagram illustrating an embodiment of a computing environment system in accordance with one or more exemplary embodiments.

Reference is made in the following detailed description to the accompanying drawings, which form a part hereof, wherein like numerals may designate like parts throughout to indicate corresponding or analogous elements. It will be appreciated that for simplicity and/or clarity of illustration, elements illustrated in the figures have not necessarily been drawn to scale. For example, the dimensions of some of the elements may be exaggerated relative to other elements for clarity. Further, it is to be understood that other embodiments may be utilized and structural and/or logical changes may be made without departing from the scope of claimed subject matter. It should also be noted that directions and references, for example, up, down, top, bottom, and so on, may be used to facilitate the discussion of the drawings and are not intended to restrict the application of claimed subject matter. Therefore, the following detailed description is not to be taken in a limiting sense and the scope of claimed subject matter defined by the appended claims and their equivalents.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail.

As will be described in greater detail below, methods and apparatuses may be implemented to develop a hierarchical taxonomy based at least in part on a cross-lingual query classification. Such cross-lingual query classification may be utilized to address continuing growth in non-English Web usage. Such non-English Web usage continues to grow; however, available language processing tools and resources may be predominantly English-based. Hierarchical taxonomies may be one a case in point. For example, while there may be a number of commercial and non-commercial hierarchical taxonomies for the English Web usage, taxonomies for other non-English languages may either be not available or may be of arguable quality. Additionally, currently, building comprehensive taxonomies for each individual language may be prohibitively expensive. Accordingly methods and apparatuses described herein may be utilized to leverage existing English taxonomies, possibly via machine translation, to provide text processing tasks in other languages.

Search engines may typically perform searches based on plan text queries. In some cases, search results may be associated with a classification with respect to a hierarchical taxonomy. As used herein, the term “hierarchical taxonomy” may refer to a tree structure that represents a hierarchy of concepts in human knowledge related to text queries. Such a hierarchical taxonomy may include an orderly classification of subject matter according to their natural relationships. Such a hierarchical taxonomy may contain different levels of hierarchy that may be divided at varying levels of granularity.

Individual level of hierarchy may contain one or more categories (also referred to herein as class labels). As used herein the term “class label” may refer to a category defined to classify queries, such as by subject-matter. Such class labels may be divided at varying level of granularity within the levels of hierarchy. For example, a first level of hierarchy may contain general class labels, such as entertainment, travel, sports, etc., followed by subsequent levels of hierarchy that contain class labels that increase in specificity in relation to the increasing levels of hierarchy. In the same example, a second level hierarchy may contain the class label “music,” a third level hierarchy may contain the class label “genre,” a fourth level hierarchy may contain the class label “band,” a fifth level hierarchy may contain the class label “albums,” a sixth level hierarchy may contain the class label “songs,” etc., for example. Individual class labels within the taxonomy may be provided with a category index number that may be used to identify the class labels and the corresponding queries that are associated with the class labels.

Such a hierarchical taxonomy may classify any number of queries within such class labels. As used herein the term “classify” may refer to associating a given query with one or more class labels of a given hierarchical taxonomy. For example, a machine learning function may be “trained” by training data, e.g. inputs may be associated with target outputs, in order to predict the classification of un-categorized queries. Additionally or alternatively, such training data may include manually and/or automatically categorized queries in such a hierarchical taxonomy. For example, using a selection technique, such as voting, a suitable classification may be determined for a query. In such a case, nodes of a hierarchical taxonomy that may be most relevant to such a query may be determined by reference to search results, as well as their ancestors in the hierarchical taxonomy.

As will be described in greater detail below, methods and apparatuses may be implemented utilizing two areas of classification: cross-language text classification (CLTC) and query classification (QC). There may be at least two approaches to cross-language text classification: poly-lingual training, where a classifier may be trained on labeled training electronic documents in multiple languages, and cross-lingual training, where a classifier may be trained in one native language, and documents in other languages are completely or selectively translated into the native language for classification. Query classification may be considered as a special case of text classification in general, but may present increased difficultly in classification due to brevity of queries. In some cases, query classification may utilize a blind relevance feedback technique. Such a blind relevance feedback technique may determine a class label associated with a given query by classifying search results retrieved for the query.

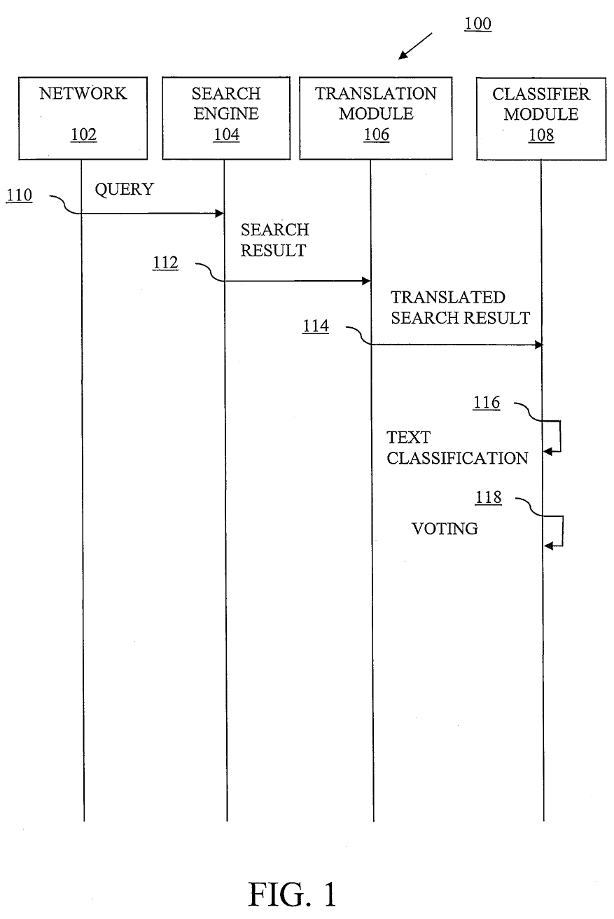

FIG. 1 is an illustrative flow diagram of a process 100 which may be utilized to develop a hierarchical taxonomy based at least in part on a cross-lingual query classification in accordance with some embodiments of the invention. Additionally, although procedure 100, as shown in FIG. 1, comprises one particular order of actions, the order in which the actions are presented does not necessarily limit claimed subject matter to any particular order. Likewise, intervening actions not shown in FIG. 1 and/or additional actions not shown in FIG. 1 may be employed and/or actions shown in FIG. 1 may be eliminated, without departing from the scope of claimed subject matter. Procedure 100 depicted in FIG. 1 may in alternative embodiments be implemented in software, hardware, and/or firmware, and may comprise discrete operations.

As illustrated, procedure 200 procedure 200 governs the operation of a classifier module 108 associated with network 102, search engine 104, and translation module 106. Search engine 104 may be capable of searching for content items of interest. Search engine 104 may communicate with a network 102 to access and/or search available information sources. By way of example, but not limitation, network 102 may include a local area network, a wide area network, the like, and/or combinations thereof, such as, for example, the Internet. Additionally or alternatively, search engine 104 and its constituent components may be deployed across network 102 in a distributed manner, whereby components may be duplicated and/or strategically placed throughout network 102 for increased performance.

Search engine 104 may include multiple components. For example, search engine 104 may include a ranking component and/or a crawler component. Additionally or alternatively, search engine 104 also may include various additional components. For example, search engine 104 may also include classifier module 108 and/or translation module 106. Alternatively, search engine 104 may not itself include classifier module 108 and/or translation module 106. Search engine 104, as shown in FIG. 1, is described herein with non-limiting example components. Thus, as mentioned, further additional components may be employed, without departing from the scope of claimed subject matter.

At action 110, a search query may be provided to search engine 104. At action 112, a search result may be retrieved based at least in part on a query of a first language (also referred to herein as a native language). For example, search engine 104 may perform a search on the Internet for content such as electronic documents that meet the search query to prepare a search result. In response to such a search query, search engine 104 may produce a search result that may include multiple electronic documents ranked based at least in part upon relevance to the search query according to scoring criteria used by the search engine 104.

As used herein, the term “electronic document” may include any information in a digital format that may be perceived by a user if displayed by a digital device, such as, for example, a computing platform. For one or more embodiments, an electronic document may comprise a web page coded in a markup language, such as, for example, HTML (hypertext markup language). However, the scope of claimed subject matter is not limited in this respect. Also, for one or more embodiments, the electronic document may comprise a number of elements. The elements in one or more embodiments may comprise text, for example, as may be displayed on a web page. Also, for one or more embodiments, the elements may comprise a graphical object, such as, for example, a digital image. Unless specifically stated, an electronic document may refer to either the source code for a particular web page or the web page itself. Each web page may contain embedded references to images, audio, video, other web documents, etc. One common type of reference used to identify and locate resources on the web is a Uniform Resource Locator (URL).

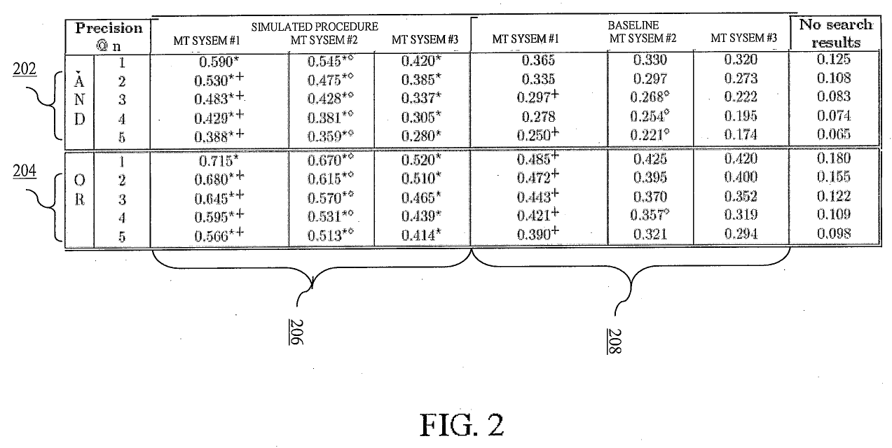

Referring to FIG. 2, simulated results implementing portions of one or more embodiments were obtained in accordance with some embodiments of the invention. In such simulations, a given non-English query was dispatched to one or more major search engines to retrieve search results in the query's native language. In this study, queries were dispatched to a commercially available search engine to retrieve up to 32 search results, based at least in part on limits imposed by the commercially available search engine. Such search results were crawled from the Web using the returned URLs. When a fresh copy was not available, a cached electronic document was retrieved with the cache header removed to ensure that these electronic documents were comparable to the original pages.

Such crawled electronic documents were processed to remove tags, java scripts, and/or other non-content information. In cases where returned results were not HTML files (e.g., PDF files, MS Word documents, etc.), such files were removed from consideration. The resulting non-English native language textual content was re-encoded into UTF-8, regardless of what the original encoding was.

Referring back to FIG. 1, at action 114, at least a portion of such a search result may be translated from a native language to a second language (also referred to herein as a target language). For example, such a translation of at least a portion of such a search result may be based at least in part on a machine translation by translation module 106. Translation module 106 may include an off-the-shelf machine translation system, specially developed machine translation system, the like, and/or combinations thereof.

While the field of machine translation has advanced significantly over the recent years, it may still not be feasible to depend on machine translation systems to reliably translate training examples for developing hierarchical taxonomies into a target language, owing to less-than perfect quality of machine translation output. Instead, machine translation systems may be utilized in procedure 100 to provide a potentially imperfect mapping between an original language and a target language, by utilizing machine translation output as an intermediate step that may undergo further processing. Such indirect use of machine translation systems may allows procedure 100 to more robustly tolerate occasional translation errors.

Referring back to FIG. 2, simulated results implementing machine translation techniques in accordance with one or more embodiments were utilized to translate crawled electronic documents into a target language of English via an off-the-shelf machine translation system. To study the impact of using different machine translation systems, several different systems that were accessible over the Web

Referring back to FIG. 1, at action 116, a translated portion of such search results may be classified. For example, such a classification of a translated portion of such search results may be based at least in part on a classification by classification module 108. Classification module 108 may include an off-the-shelf classification system, specially developed classification system, the like, and/or combinations thereof. Such classification may associate multiple class labels with at least one of such electronic documents, for example. As used herein the term “class label” may refer to category labels assigned in text classification, where such categories may come from a set of labels (possibly organized in a hierarchy) and individual electronic document may be assigned one or more of such categories.

Referring back to FIG. 2, simulated results implementing text classification techniques in accordance with one or more embodiments were utilized to classify translated electronic document into a target language English taxonomy. The type of classification module utilized in simulation was a centroid-based classifier trained on English data. During such classification, up to five ranked class labels were returned for individual electronic documents.

Referring back to FIG. 1, at action 118, wherein said classifying said query is based at least in part on determining a vote among such class labels. For example, such voting may be based at least in part on a majority vote among such class labels via classification module 108. Likewise, such voting may be weighted based at least in part on a confidence in individual class labels and/or the like. As will be described in more detail below, classification of the query itself may be based at least in part on such a majority vote, and/or the like. Accordingly, classification of the query itself may be inferred based at least in part on the classified translated portion of such search results. In such a case, such a query may be classified within a hierarchical taxonomy of a target language based at least in part on a translated portion of a search result, where the search result has been translated into such a target language from a native language.

Referring back to FIG. 2, simulated results implementing voting techniques in accordance with one or more embodiments were utilized to infer a query classification from the page classes. More specifically, we take the majority vote from class labels associated with such translated portion of such search results. For example, multiple class labels may be associated with individual electronic documents and may be utilized to infer a class label of the original query. In one example, individual translated electronic documents may contribute up to five votes equally.

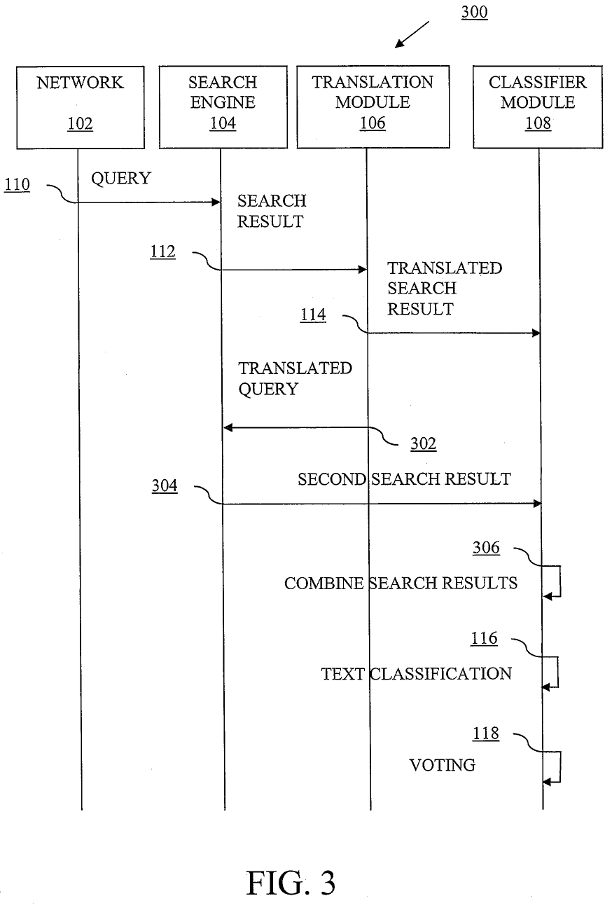

FIG. 3 is an illustrative flow diagram of a process 300 which may be utilized to develop a hierarchical taxonomy based at least in part on a cross-lingual query classification in accordance with some embodiments of the invention. Additionally, although procedure 300, as shown in FIG. 3, comprises one particular order of actions, the order in which the actions are presented does not necessarily limit claimed subject matter to any particular order. Likewise, intervening actions not shown in FIG. 3 and/or additional actions not shown in FIG. 3 may be employed and/or actions shown in FIG. 3 may be eliminated, without departing from the scope of claimed subject matter. Procedure 300 depicted in FIG. 3 may in alternative embodiments be implemented in software, hardware, and/or firmware, and may comprise discrete operations.

As illustrated, procedure 300 may operate in a similar manner at actions 110, 112, 114, 116, and 118. However, additional operations may be included as illustrated by procedure 300. At action 302, at least a portion of a query may be translated. For example at least a portion of a query may be translated from a native language to a target language via translation module 106. At action 304, a second search result may be retrieved. For example, such a second search result may be retrieved from search engine 104 based at least in part on such a translated portion of a given query. At action 306, such a second search result may be combined with the previous search result from action 114. For example, at least a portion of such a translated portion of a first search result 114 may be combined with at least a portion of a second search result 302. Accordingly, data supplied to classifier module from the previous search result 114 may be based at least in part on a translated search result, while data supplied to classifier module from the second search result 302 may be based at least in part on a translated query.

As is similarly described in FIG. 1, at action 116, classification of such a combination of a first search result and a second search result may associate multiple class labels with at least one of electronic documents identified by such search results. As described above, at action 118, classification of a query may be based at least in part on determining a vote among such class labels. Additionally or alternatively, determination of a vote among such class labels may be based at least in part on assigning a different (e.g., greater) weight to class labels associated with first search result 114 as compared to class labels associated with second search result 304. Accordingly, classifying a query within a hierarchical taxonomy of a target language may be based at least in part on at least a portion of second search result 202.

In operation, procedure 300 may prove useful in situation where there may be more and/or better information in electronic documents in such a target language (such as English electronic documents when a non-English native language query is submitted). In such a case, significant terms and/or concepts may be target language (such as English) in origin and accurately may be improved by including such a target language electronic document prior to voting.

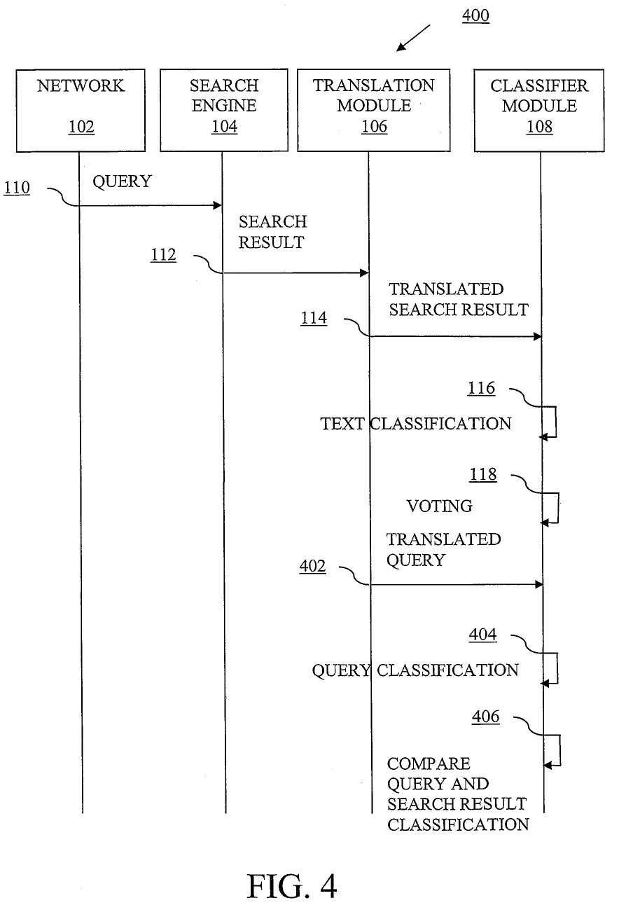

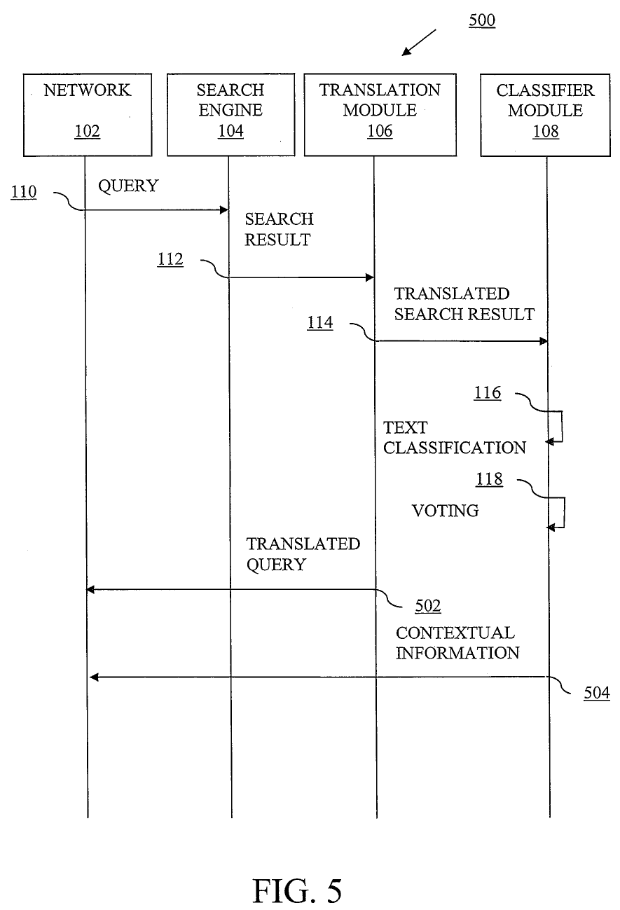

FIG. 4 is an illustrative flow diagram of a process 400 which may be utilized to determine if a translation of a query is accurate in accordance with some embodiments of the invention. Additionally, although procedure 400, as shown in FIG. 4, comprises one particular order of actions, the order in which the actions are presented does not necessarily limit claimed subject matter to any particular order. Likewise, intervening actions not shown in FIG. 4 and/or additional actions not shown in FIG. 4 may be employed and/or actions shown in FIG. 4 may be eliminated, without departing from the scope of claimed subject matter. Procedure 400 depicted in FIG. 4 may in alternative embodiments be implemented in software, hardware, and/or firmware, and may comprise discrete operations.

As illustrated, procedure 400 may operate in a similar manner at actions 110, 112, 114, 116, and 118. However, additional operations may be included as illustrated by procedure 400. At action 402, at least a portion of a query may be translated. For example, at least a portion of a query may be translated via translation module 106 from a native language (such as non-English) to a target language (such as English) and may be delivered to classifier module 108. At action 404, such a translated query may be classified. For example, such a translated query may be classified via classification module 108 within a hierarchical taxonomy of such a target language based at least in part on the translated query itself. In such a case, such a query may not be classified at action 404 based on the translated search result 114. At action 406, a determination may be made whether such a translation of a query may be sufficiently accurate. For example, classification module 108 may determine the accuracy of such a query translation based at least in part on a comparison of query classification 404 as compared with query classification 118.

In operation, such a determination of the accuracy of such a query may be utilized to determine if a translation is correct. In such a case, such a “query” may not necessarily imply an Internet search operation, and may instead refer to a term and/or phrase submitted directly to a translation module 106 for translation. In cases where such a translation is accurate, query classification 404 may be more likely to be similar to query classification 118. Conversely, in cases where such a translation is inaccurate, query classification 404 may be less likely to be similar to query classification 118.

FIG. 5 is an illustrative flow diagram of a process 500 which may be utilized to determine if a translation of a query is accurate in accordance with some embodiments of the invention. Additionally, although procedure 500, as shown in FIG. 5, comprises one particular order of actions, the order in which the actions are presented does not necessarily limit claimed subject matter to any particular order. Likewise, intervening actions not shown in FIG. 5 and/or additional actions not shown in FIG. 5 may be employed and/or actions shown in FIG. 5 may be eliminated, without departing from the scope of claimed subject matter. Procedure 500 depicted in FIG. 5 may in alternative embodiments be implemented in software, hardware, and/or firmware, and may comprise discrete operations.

As illustrated, procedure 500 may operate in a similar manner at actions 110, 112, 114, 116, and 118. However, additional operations may be included as illustrated by procedure 500. At action 502, at least a portion of a query may be translated. For example, at least a portion of a query may be translated via translation module 106 from a native language (such as non-English) to a target language (such as English) and may be delivered to a user via network 102. At action 504, contextual information regarding such a query may be transmitted. For example, such contextual information regarding such a query may be transmitted from classifier module 108 and may be delivered to a user via network 102. Such contextual information may be based at least in part on query classification 118.

In operation, such a procedure regarding the accuracy of such a query may be utilized to by a user to determine if a translation is correct. In such a case, such a “query” may not necessarily imply an Internet search operation, and may instead refer to a term and/or phrase submitted directly to a translation module 106 for translation. For example, a user may enter a query term and/or phrase. In addition to receiving a translation of the query, a user may also receive contextual information that may assist a user in determining if the translation is accurate. For example, such contextual information may indicate the general subject matter of the query term and/or phrase. In cases where such a translation is accurate, such a query may be more likely to be similar to query classification 118. Conversely, in cases where such a translation is inaccurate, such a query may be less likely to be similar to query classification 118.

Referring back to FIG. 1, in operation, procedure 100 may be utilized to address continuing growth in non-English Web usage. Such non-English Web usage continues to grow; however, available language processing tools and resources may be predominantly English-based. Taxonomies may be one a case in point. For example, while there may be a number of commercial and non-commercial taxonomies the English Web usage, taxonomies for other non-English languages may either be not available or may be of arguable quality. Additionally, currently, building comprehensive taxonomies for each individual language may be prohibitively expensive. Accordingly procedure 100 may be utilized to leverage existing English taxonomies, possibly via machine translation, to provide text processing tasks in other languages.

Conversely, one alternative way to classify a non-English native language query may be to directly machine translate the query into an English target language, and use existing techniques for English query classification. However, such an alternative may be susceptible to increased translation errors as the length of the given query is reduced. In such an alternative classification scheme, English-language query classification may utilize search results for more robust classification; however, such English search results derived from a translated query may have been corrupted by imperfect translation. Consequently, inaccurate translation of the query itself can be cascaded and may cause subsequent classification to also be inaccurate. In procedure 100 a query may be first submitted in its native language to a search engine. Accordingly, by using search results in a query's native language, in contrast to using a translated query, such risk of imperfect translation may be offset by shifting from a higher information density area (query) to a lower information density area (search results). Top-scoring search results may be collected and the result electronic documents may be translated into a target language (such as English). Such translated electronic documents may be classified into a target language hierarchical taxonomy, and voting may be performed to determine overall class labels for the original native language query.

Referring back to FIG. 2, simulated results may illustrate that cross-lingual query classification may be utilized for understanding user intent both in Web search applications and/or in online advertising applications. In simulation, existing English text classifiers and existing machine translation systems were utilized to monitor such a cross-lingual query classification procedure. In particular, simulated results may illustrate that by considering search results in a query's original language as a source of information, an effect of erroneous machine translation may be reduced.

An electronic document written in a native language (such as a non-English language), may be denoted as dₛ. Once such an electronic document is translated into a target language (such as English), it may be denoted as dₜ. Since, in one example, classification module 108 (FIG. 1) may be based at least in part on a bag-of-words representation of such electronic documents, analysis of process 100 may focus on unigram precision of the translation for simplicity. Alternatively, analysis of process 100 may instead focus on n-gram based classification. Such unigram precision may be a component of a BLEU score, which may be one measure for automatic evaluation of machine translation systems. A total number of words in dₜ may be denoted as N, and I may denote a number of correctly translated words in dₜ. In such a case a quality of a translation may be quantified by a quality factor α=I/N. This quantification may be similar to a unigram precision as discussed above with respect to a BLEU score. As illustrated in FIG. 2, a unigram precision of about 0.3 to about 0.5 was reported for example machine translation systems on sample Chinese to English translations.

For simplicity, a basic voting mechanism was utilized as a text classifier. However, other voting mechanisms may be utilized in conjunction with the procedures described herein. In such a voting mechanism, individual words may cast a vote for one of the classes and a class with a majority votes may be predicted for the text document dₜ. In addition, the simulated analysis assigned only one correct class for each query; however, more than one correct class may be appropriate depending on the particular application. Further, search results dₛ may preserve the class information of the query. An imperfect classification may be approximated with an effective document length N′<N in order to account for situations were not all words cast a vote, and with an effective quality factor α′<α to account for situations were correctly translated words casts the right vote with (a non-trivial) probability p<1. In the simulated results, it may be assumed that p=1 for simplicity; however, the simulated results may still hold for the effective quality factor α′ and effective document length N′.

Let the number of classes in a taxonomy be K (for simplicity in such an analysis, the hierarchical structure in the taxonomy may be ignored). Additionally, for simplicity in such an analysis, correctly translated words may be assumed to cast one vote on a correct class c*, and incorrectly translated words may cast a vote on one of the K classes uniformly at random. Thus, correct class c* may receive a total of αN votes, and in order for dₜ to receive an incorrect label, at least αN+1 out of the other (1−α)N votes need to aggregate over a class other than correct class c*. In this simplified setting, in cases where α>0.5, it may be impossible to classify the document incorrectly. In cases where α<0.5, the chance of at least αN+1 of the random votes aggregating into one of the K−1 incorrect classes may be considered. Out of K^{(1-α)N} possible voting configurations, at most

$$( K - 1 ) ( \begin{matrix}( 1 - α ) N \\ α N + 1\end{matrix} ) {K}^{( 1 - 2 α ) N - 1} \qquad ( 1 )$$

of them may result in at least αN+1 votes in a class other than correct class c*. That is, a chance of dₜ getting an incorrect label may be bounded by

$$( K - 1 ) ( \begin{matrix}( 1 - α ) N \\ α N + 1\end{matrix} ) {( \frac{1}{K} )}^{α N + 1} \qquad ( 2 )$$

With a fixed N, the higher α is, the lower the chance of getting an incorrect class label induced by incorrect translation may be. This may explain why the proposed procedure may produce better results as compared to classifying a translated query directly. First, as mentioned earlier, translation of short queries directly may be likely to be of lower quality since there may be less context information to resolve ambiguity during translation. In addition, as queries may be short, it may be more likely that the entire query is translated incorrectly, since K may typically be quite high (over 6000 in the case of the taxonomy utilized for the simulated results), a completely irrelevant query in the target language may be unlikely to lead to a correct label by chance. Further, even if it is assumed that multi-words queries are partially correctly translated with the same translation quality, that is, the same α, as translated electronic documents, the fact that queries are typically much shorter (e.g., much smaller N) as compared to such electronic documents may lead to a higher chance of incorrect labels. For example, in a situation where a query is translated into three words in English, with one of the words being correct, then there may be a high probability that the two incorrectly translated words will vote for incorrect classes; on the other hand, in a situation where a 300-word document, is translated into English, 100 of which are correct translations, the chance of at least 100 of the random votes from the 200 incorrectly translated words aggregated into one class may be significantly lower.

FIG. 2 reports the performance of the different procedures on a given data set. A simulated implemented of procedure 100 for cross-language query classification is itemized in columns 206. Such simulated results 206 may be compared to baseline results, where such baseline results may be based on direct query translation, as itemized in column 208. An upper part 202 of the table reports the results of using logical AND to combine editorial judgments, while the lower part 204 of the table uses logical OR. A one-tail paired t-test with p-value<0.05 was utilized to assess the statistical significance of the results. The following superscripts are used in the table to denote statistical significance. In a comparison of the performance of simulated results 206 and the baseline results 208 using similar machine translation systems, where a “*” may denotes that the performance of simulated results 206 may be statistically better than the corresponding performance of the baseline results 208. Additionally, the effect of using different MT systems may be considered for either the simulated results 206 or baseline 208, where “+” may represent that machine translation system 1 may perform statistically better than machine translation system 2, and where “⋄” may represent that machine translation system 2 may perform statistically better than machine translation system 3.

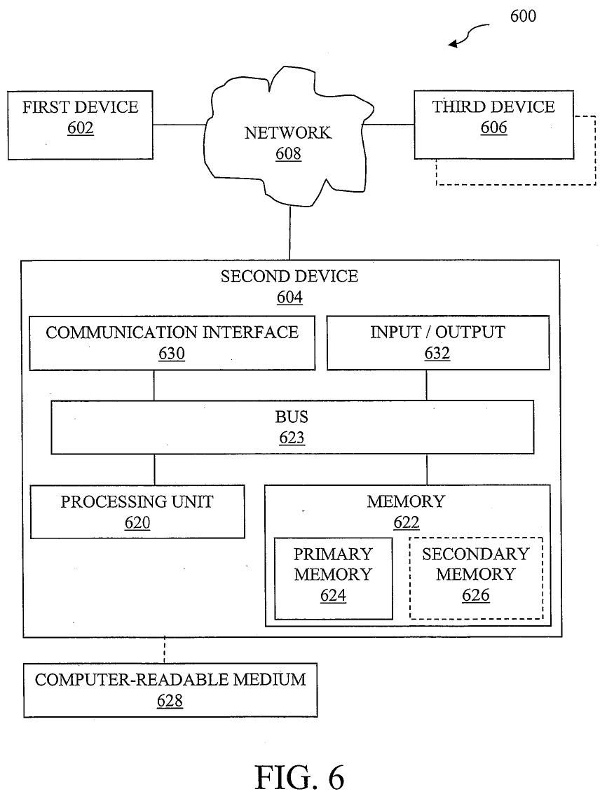

FIG. 6 is a block diagram illustrating an exemplary embodiment of a computing environment system 600 that may include one or more devices configurable to develop a hierarchical taxonomy based at least in part on a cross-lingual query classification using one or more exemplary techniques illustrated above. For example, computing environment system 600 may be operatively enabled to perform all or a portion of process 100 of FIG. 1, process 300 of FIG. 3, process 400 of FIG. 4, and/or process 500 of FIG. 5.

Computing environment system 600 may include, for example, a first device 602, a second device 604 and a third device 606, which may be operatively coupled together through a network 608.

First device 602, second device 604 and third device 606, as shown in FIG. 6, are each representative of any device, appliance or machine that may be configurable to exchange data over network 608. By way of example, but not limitation, any of first device 602, second device 604, or third device 606 may include: one or more computing platforms or devices, such as, e.g., a desktop computer, a laptop computer, a workstation, a server device, storage units, or the like.

Network 608, as shown in FIG. 6, is representative of one or more communication links, processes, and/or resources configurable to support the exchange of data between at least two of first device 602, second device 604 and third device 606. By way of example, but not limitation, network 608 may include wireless and/or wired communication links, telephone or telecommunications systems, data buses or channels, optical fibers, terrestrial or satellite resources, local area networks, wide area networks, intranets, the Internet, routers or switches, and the like, or any combination thereof.

As illustrated by the dashed lined box partially obscured behind third device 606, there may be additional like devices operatively coupled to network 608, for example.

It is recognized that all or part of the various devices and networks shown in system 600, and the processes and methods as further described herein, may be implemented using or otherwise include hardware, firmware, software, or any combination thereof.

Thus, by way of example, but not limitation, second device 604 may include at least one processing unit 620 that is operatively coupled to a memory 622 through a bus 623.

Processing unit 620 is representative of one or more circuits configurable to perform at least a portion of a data computing procedure or process. By way of example, but not limitation, processing unit 620 may include one or more processors, controllers, microprocessors, microcontrollers, application specific integrated circuits, digital signal processors, programmable logic devices, field programmable gate arrays, and the like, or any combination thereof.

Memory 622 is representative of any data storage mechanism. Memory 622 may include, for example, a primary memory 624 and/or a secondary memory 626. Primary memory 624 may include, for example, a random access memory, read only memory, etc. While illustrated in this example as being separate from processing unit 620, it should be understood that all or part of primary memory 624 may be provided within or otherwise co-located/coupled with processing unit 620.

Secondary memory 626 may include, for example, the same or similar type of memory as primary memory and/or one or more data storage devices or systems, such as, for example, a disk drive, an optical disc drive, a tape drive, a solid state memory drive, etc. In certain implementations, secondary memory 626 may be operatively receptive of, or otherwise configurable to couple to, a computer-readable medium 628. Computer-readable medium 628 may include, for example, any medium that can carry and/or make accessible data, code and/or instructions for one or more of the devices in system 600.

Second device 604 may include, for example, a communication interface 630 that provides for or otherwise supports the operative coupling of second device 604 to at least network 608. By way of example, but not limitation, communication interface 630 may include a network interface device or card, a modem, a router, a switch, a transceiver, and the like.

Second device 604 may include, for example, an input/output 632. Input/output 632 is representative of one or more devices or features that may be configurable to accept or otherwise introduce human and/or machine inputs, and/or one or more devices or features that may be configurable to deliver or otherwise provide for human and/or machine outputs. By way of example, but not limitation, input/output device 632 may include an operatively enabled display, speaker, keyboard, mouse, trackball, touch screen, data port, etc.

Some portions of the detailed description are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is here, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

Reference throughout this specification to “one embodiment” or “an embodiment” means that a particular feature, structure, or characteristic described in connection with the embodiment is included in at least one embodiment of claimed subject matter. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more embodiments.

The term “and/or” as referred to herein may mean “and”, it may mean “or”, it may mean “exclusive-or”, it may mean “one”, it may mean “some, but not all”, it may mean “neither”, and/or it may mean “both”, although the scope of claimed subject matter is not limited in this respect.

While certain exemplary techniques have been described and shown herein using various methods and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter also may include all implementations falling within the scope of the appended claims, and equivalents thereof.

What is claimed is:

1. A method, comprising:
retrieving a search result based at least in part on a query of a first language;
receiving a translation of at least a portion of said search result from said first language to a second language; and
classifying said query within a hierarchical taxonomy of said second language based at least in part on said translated portion of said search result.

2. The method of claim 1, further comprising classifying said translated portion of said search result.

3. The method of claim 1, further comprising:
classifying said translated portion of said search result, wherein said translated portion of said search result comprises one or more electronic documents, and wherein said classifying associates two or more class labels with at least one of said one or more electronic documents; and
wherein said classifying said query is based at least in part on said class labels.

4. The method of claim 1, further comprising:
classifying said translated portion of said search result, wherein said translated portion of said search result comprises one or more electronic documents, and wherein said classifying associates two or more class labels with at least one of said one or more electronic documents; and
wherein said classifying said query is based at least in part on determining a majority vote among said class labels.

5. The method of claim 1, wherein said translation of at least a portion of said search result from said first language to said second language is based at least in part on a machine translation.

6. The method of claim 1, further comprising:
receiving a translation of at least a portion of said query from said first language to said second language;
retrieving a second search result based at least in part on said translated portion of said query; and
wherein said classifying comprises classifying said query within said hierarchical taxonomy of said second language based at least in part on at least a portion of said second search result.

7. The method of claim 1, further comprising:
receiving a translation of at least a portion of said query from said first language to said second language;
retrieving a second search result based at least in part on said translated portion of said query;
combining at least a portion of said translated portion of said search result with at least a portion of said second search result;
classifying said combination of said search result and said second search result, wherein said combination of said search result and said second search result comprises one or more electronic documents, and wherein said classifying associates two or more class labels with at least one of said one or more electronic documents; and
wherein said classifying said query is based at least in part on determining a majority vote among said class labels.

8. The method of claim 7, wherein said determining of said majority vote among said class labels is based at least in part on assigning a greater weight to class labels associated with said search result as compared to class labels associated with said second search result.

9. The method of claim 1, further comprising:
receiving a translation of at least a portion of said query from said first language to said second language;
classifying said translated query within a hierarchical taxonomy of said second language based at least in part on said translated query;
determining if said translation of said query is accurate based at least in part on a comparison of said classification based at least in part on said translated query with said classification based at least in part on said translated portion of said search result.

10. The method of claim 1, further comprising:
receiving said query from a user device;
receiving a translation of at least a portion of said query from said first language to said second language; and
transmitting said translated query and contextual information to said user device, wherein said contextual information is based at least in part on said classification.

11. An article comprising:
a storage medium comprising machine-readable instructions stored thereon, which, if executed by one or more processing units, operatively enable a computing platform to:
retrieve a search result based at least in part on a query of a first language;
receive a translation of at least a portion of said search result from said first language to a second language; and
classify said query within a hierarchical taxonomy of said second language based at least in part on said translated portion of said search result.

12. The article of claim 11, wherein said machine-readable instructions, if executed by the one or more processing units, operatively enable the computing platform to:
classify said translated portion of said search result, wherein said translated portion of said search result comprises one or more electronic documents, and wherein said classification associates two or more class labels with at least one of said one or more electronic documents; and
wherein said classification of said query is based at least in part on a determination of a majority vote among said class labels.

13. The article of claim 12, wherein said machine-readable instructions, if executed by the one or more processing units, operatively enable the computing platform to:
receive a translation of at least a portion of said query from said first language to said second language;
retrieve a second search result based at least in part on said translated portion of said query;
combine at least a portion of said translated portion of said search result with at least a portion of said second search result;
classify said combination of said search result and said second search result, wherein said combination of said search result and said second search result comprises one or more electronic documents, and wherein said classification associates two or more class labels with at least one of said one or more electronic documents; and
wherein said classification of said query is based at least in part on determination of a majority vote among said class labels, and wherein said determination of said majority vote among said class labels is based at least in part on assignment of a greater weight to class labels associated with said search result as compared to class labels associated with said second search result.

14. The article of claim 11, wherein said machine-readable instructions, if executed by the one or more processing units, operatively enable the computing platform to:
receive a translation of at least a portion of said query from said first language to said second language;
classify said translated query within a hierarchical taxonomy of said second language based at least in part on said translated query;
determine if said translation of said query is accurate based at least in part on a comparison of said classification based at least in part on said translated query with said classification based at least in part on said translated portion of said search result.

15. The article of claim 11, wherein said machine-readable instructions, if executed by the one or more processing units, operatively enable the computing platform to:
receive said query from a user device;
receive a translation of at least a portion of said query from said first language to said second language; and
transmit said translated query with contextual information to said user device, wherein said contextual information is based at least in part on said classification.

16. An apparatus comprising:
a computing platform, said computing platform being operatively enabled to:
retrieve a search result based at least in part on a query of a first language;
receive a translation of at least a portion of said search result from said first language to a second language; and
classify said query within a hierarchical taxonomy of said second language based at least in part on said translated portion of said search result.

17. The apparatus of claim 16, wherein said machine-readable instructions, if executed by a computing platform, further direct a computing platform to:
classify said translated portion of said search result, wherein said translated portion of said search result comprises one or more electronic documents, and wherein said classification associates one or more class labels with at least one of said one or more electronic documents; and
wherein said classification of said query is based at least in part on a determination of a majority vote among said class labels.

18. The apparatus of claim 16, wherein said machine-readable instructions, if executed by a computing platform, further direct a computing platform to:
receive a translation of at least a portion of said query from said first language to said second language;
retrieve a second search result based at least in part on said translated portion of said query;
combine at least a portion of said translated portion of said search result with at least a portion of said second search result;
classify said combination of said search result and said second search result, wherein said combination of said search result and said second search result comprises one or more electronic documents, and wherein said classification associates two or more class labels with at least one of said one or more electronic documents; and
wherein said classification of said query is based at least in part on determination of a majority vote among said class labels, and wherein said determination of said majority vote among said class labels is based at least in part on assignment of a greater weight to class labels associated with said search result as compared to class labels associated with said second search result.

19. The apparatus of claim 16, wherein said machine-readable instructions, if executed by a computing platform, further direct a computing platform to:
receive a translation of at least a portion of said query from said first language to said second language;
classify said translated query within a hierarchical taxonomy of said second language based at least in part on said translated query;
determine if said translation of said query is accurate based at least in part on a comparison of said classification based at least in part on said translated query with said classification based at least in part on said translated portion of said search result.

20. The apparatus of claim 16, wherein said machine-readable instructions, if executed by a computing platform, further direct a computing platform to:
receive said query from a user device;
receive a translation of at least a portion of said query from said first language to said second language; and
transmit said translated query with contextual information to said user device, wherein said contextual information is based at least in part on said classification.
